(19) United States
(12) Patent Application Publication
(10) Pub. No.: US 2005/0159824 A1
(43) Pub. Date: Jul. 21, 2005

(54) Recurrent distribution network with input boundary limiters

(76) Inventor: Ronald L. Childress JR., Easley, SC (US)

Correspondence Address: DUANE MORRIS LLP, P. O. BOX 1003, 305 NORTH FRONT STREET, 5TH FLOOR, HARRISBURG, PA, 17108-1003, US

(21) Appl. No.: 10/923,963

(22) Filed: Aug. 23, 2004

Related U.S. Application Data
(60) Provisional application No. 60/537,601, filed on Jan. 20, 2004.

(51) Int. Cl. G05B 13/02; G05D 3/12; G05D 17/00; G05D 11/00; G05D 5/00; G05D 9/00

(52) U.S. Cl. 700/33

(57) ABSTRACT

A recurrent distribution network provides an embedded, cost-based decision mechanism for a real-time, closed-loop process control system that outputs to multiple controllable output devices while observing numerous input constraints. A global incremental distribution request to increase or decrease a controlled process variable is accepted by a recurrent neural network. The network iteratively solves and applies a distribution of a global incremental request to multiple controllable output devices based on individual incremental unit costs, output ranges, output scaling and process input constraint limits.

### CROSS-REFERENCE OF RELATED APPLICATIONS

This application is related to, and claims priority from provisional patent application Ser. No. 60/537,601, filed Jan. 20, 2004.

### FIELD OF THE INVENTION

The present invention generally relates to control systems, and more particularly to energy distribution and control networks having controlled boundary conditions.

### BACKGROUND OF THE INVENTION

As it becomes more expensive for energy providers to increase generation, distribution, and transmission capacity a number of strategies have emerged for coping with increasing demand. One of these is called demand side management in which the users of energy themselves are adapted to reduce the amount of energy they use during times of peak power usage as well as in other similar situations. For example, U.S. Pat. No. 5,598,349, issued to Elliason et al., discloses a method for employing utility-supplied information. It relies upon two schemes for accommodating such pricing information. All subsystems in a building function based upon the individual controller responsible for that subsystem and sets of user-defined predetermined responses that are stored in memory. Direct load control and user overrides are also allowed. Where appropriate, a setback is applied across subsystems that operate on setpoints, and other loads are add/shed controlled based upon their value, vis-à-vis, interpreted utility pricing information signals.

In U.S. Pat. No. 6,181,985, issued to O'Donnell et al., a load shed module for use in a power distribution system is provided that includes facility for delivering both electrical power and electrical power rate information from a utility supplier. The load shed module includes an enclosure having a power plug for receipt in a standard utility power outlet, such as a wall socket, and a power socket on the enclosure for connection to a power load. A relay switch is disposed within the enclosure for selectively electrically connecting the plug to the socket to deliver electrical power to the load coupled to the socket. A rotary switch is mounted on the enclosure, and rotary rate indicia are provided on the enclosure adjacent to the rotary switch and coordinated with position of the rotary switch for operator selection of a rate tier at which the socket is to be disconnected from the plug. Utility power rate information is received from the utility supplier and compared with the rate tier selected by the operator at the rotary switch. When the power rate information equals or exceeds the selected rate tier, the module socket is disconnected from the plug so that the associated load is effectively disconnected from the power distribution system.

In U.S. Pat. No. 6,185,483, issued to Drees, a method and apparatus are provided for controlling an energy storage medium connected to an environmental control system that is providing environmental conditioning. The controller includes an energy pricing data structure for storing a real-time energy pricing profile indicative of energy rates corresponding to time-varying production costs of energy. The controller also includes a storage medium containing rules that approximate optimal control trajectories of an energy cost function that is dependent upon a real-time energy pricing profile, with the rules governing the operation of the energy storage medium. The controller has an engine for generating a storage medium control signal based upon the real-time energy pricing profile and the rules whereby the energy storage medium is controlled with the storage medium control signal in order to minimize energy costs associated with the environmental control system.

In U.S. Pat. No. 6,487,509, issued to Aisa, an apparatus and method are disclosed for management of energy consumption by appliances connected to a powered network. A plurality of appliances are each provided with a programmed electronic control system adapted to transmit and receive, to and from, other electronic control systems and a device for measuring total network power consumption. Each control system adjusts the power consumption of its corresponding appliance in accordance with information that it receives and the instructions with which it is programmed without need for a central control unit or user intervention.

In U.S. Pat. No. 6,553,418, issued to Collins et al., an energy management system is disclosed for monitoring and analyzing the power consumption at a plurality of locations. The energy management system includes a primary server connected to a building server or other device through a computer network. Each of the building servers are connected to one or more energy meters contained in a building. The primary server sends out a data request and receives energy usage information from each of the individual building servers. The primary server stores the energy usage information in a power database such that the information can be processed in a variety of manners, such as, by aggregating the energy usage information from multiple locations into a single energy consumption statistic. The primary server can be accessed by remote monitoring stations to view and analyze the energy usage information stored in the power database.

In U.S. Pat. No. 6,603,218, issued to Aisa, a method for managing the energy consumption of electricity users is disclosed, including household appliances, in a domestic environment. The users are each operatively connected in a network where each one of the users presents an electric load to a source of electricity. The method of operation includes presetting an appropriate maximum limit of power which can be supplied by the source of electricity. Each user is provided with control means for managing its own consumption of electricity. The instantaneous total consumption of the electricity supplied by source to the domestic environment is measured and transmitted to control means for each one of the users. The network information relating to the instantaneous total consumption of the supplied electricity is provided thereby making the control means of each one of the users capable of adjusting the electric load being presented to the source of energy by the respective user in response to the information.

In U.S. Pat. No. 6,633,823, issued to Bartone et al., a system and method are disclosed for real time monitoring and control of energy consumption at a number of facilities to allow aggregate control over the power consumption. A central location receives information over a communications network, such as a wireless network, from nodes placed at facilities. The nodes communicate with devices within the facility that monitor power consumption, and control electrically driven devices within the facility. The electrically driven devices may be activated or deactivated remotely by the central location. This provides the ability to load balance a power consumption grid and thereby proactively conserve power consumption, as well as, avoid expensive spikes in power consumption. A wireless network is also provided for communicating with the facilities which allows other information to be collected and processed.

Many of the foregoing devices, systems and methods address the need to manage consumption of electrical appliances. None of the foregoing devices, systems, and methods have been found to be completely satisfactory, however, in addressing or controlling the economic distribution of resources within multiple constraint boundaries, particularly for the dynamic and economic control and distribution of multiple energy sources for generating power in the form of steam, electricity, air and water. There is a need for a distribution network, e.g., an energy distribution grid, for use as an embedded, cost-based decision mechanism for a real-time, closed-loop, process control system that outputs to multiple devices while observing numerous input constraints, such as incremental unit costs, output ranges, output scaling and process input constraint limits, and which efficiently and rapidly controls a monitored process variable.

### SUMMARY OF THE INVENTION

In one aspect, the present invention provides a control apparatus for controlling a controlled process variable in a system. The control apparatus comprises a plurality of cooperative distribution hubs, each coupled to an associated controllable output device that affects the controlled process variable. The apparatus includes a corresponding plurality of connection hubs, each inputting information to a corresponding distribution hub and coupled to a plurality of boundary limiting devices. Each boundary limiting device receives at least an input signal indicative of a corresponding dependent process variable and includes limiting means for comparing the input signal to low and high boundary limits and sending means for sending output signals to the connection hub. Also provided are means for sending a global request to adjust the controlled process variable, to the plurality of cooperating distribution hubs, adjusting means for the plurality of cooperating distribution hubs to cooperatively adjust at least one of the controllable output devices to adjust the controlled process variable using heuristic rules, responsive to the global request, and based on the information.

In another aspect the invention provides a method for controlling a controlled process variable in a system. A plurality of cooperative distribution hubs is provided, each coupled to an associated controllable output device that affects the controlled process variable. A corresponding plurality of connection hubs, each coupled to a plurality of boundary limiting devices, is also provided. The method includes causing an input signal indicative of a dependent process variable to be delivered to each boundary limiting device, each boundary limiting device comparing the input signal to at least one boundary limit and sending output signals including the input signal, to an associated one of the connection hubs; and the connection hubs sending information based on the output signals, to an associated one of the distribution hubs. The method also provides for sending a global request to control the controlled process variable, to the plurality of cooperating distribution hubs. The plurality of cooperating distribution hubs cooperatively adjust at least one of the controllable output devices to control the controlled process variable by exchanging the information and using heuristic rules, responsive to the global request and based on the information.

### BRIEF DESCRIPTION OF THE DRAWINGS

These and other features and advantages of the present invention will be more fully disclosed in, or rendered obvious by, the following detailed description of the embodiments of the invention, which is to be considered together with the accompanying drawings wherein like numbers refer to like parts and further wherein:

FIG. 1 is a schematic diagram illustrating a recurrent distribution network formed in accordance with an embodiment of the present invention;

FIG. 2 is a schematic diagram illustrating sparsely interconnected generalized neural nodes forming the basis of a distribution hub formed in accordance with the present invention;

FIG. 3 is a schematic diagram of a generalized neural node;

FIG. 4 is a schematic diagram illustrating input and output variables associated with a typical input boundary limiter;

FIG. 5 is a schematic diagram illustrating the interconnection details of an exemplary input boundary limiter formed from a plurality of generalized neural nodes;

FIG. 6 is a graphical representation of the input and output relationships for each input and neural node output associated with an input boundary limiter;

FIG. 7 is a graphical representation of break point gain adjustments;

FIG. 8 is a schematic diagram illustrating neural diagnostic messaging node outputs associated with an input boundary limiter;

FIG. 9 is a graphical representation of the neural diagnostic messaging node output illustrated in FIG. 8;

FIG. 10 is a schematic illustration of a connection pod network used to interface one or more input boundary limiters to an associated distribution hub;

FIG. 11 is a schematic illustration of a connection pod network similar to FIG. 10, showing one input boundary limiter inhibiting inputs fully connected to all other input boundary limiter inhibit inputs;

FIG. 12 is a schematic diagram similar to FIGS. 10 and 11, and illustrating a fully interconnected exemplary connection pod network;

FIG. 13 is a schematic diagram similar to FIGS. 10, 11, and 12, illustrating an exemplary connection pod with enabled wiring connections;

FIG. 14 is a flow chart showing the operation of a distribution hub; and

FIG. 15 is a schematic diagram illustrating an example of a control application using a recurrent distribution network solution formed in accordance with the present invention.

### DETAILED DESCRIPTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic, diagrammatic, or graphical form in the interest of clarity and conciseness. The term “operatively connected” is an attachment, coupling, communication, or connection that allows the pertinent structures, systems, or system components to operate as intended by virtue of that relationship. In the claims, means-plus-function clauses are intended to cover the structures, systems, and system components described, suggested, or rendered obvious by the written description or drawings for performing the recited function, including not only structural and system equivalents but also equivalent structures and systems.

An aspect of the present invention provides a recurrent distribution network which avoids many problems associated with prior art process control systems. Recurrent distribution networks advantageously observe multiple process and environmental constraints and are useful in many industrial processes. A useful advantage of the recurrent distribution network of the invention, over traditional global optimization approaches, is speed. The recurrent distribution network may dynamically determine incremental distribution allotments to each output device at a typical digital controller scan rate of 1 second or faster because the solution is determined using heuristic rules and not rigid state equations. Traditional global optimization solutions are reached in a matter of minutes, even with modern computer resources. Many process systems have time constants that are much faster than the global optimizers can solve and react, making traditional global optimizers unsuitable for those applications.

The invention provides a recurrent distribution network that is suitable for use as an embedded system for real-time, cost-based, closed-loop process control that is applicable to a wide variety of dynamic industrial and residential processes and systems, e.g., chemical processing, and pharmaceutical manufacturing, as well as steam, air, water, electricity and fuel distribution optimization, where such processes and systems have multiple process and environmental constraints. Of course the present invention is not limited to only the foregoing chemical and energy-related systems, but is also applicable to a wide variety of complex, multi-variable process control applications.

An example application in which a recurrent distribution network of the present invention out-performs a traditional global optimizer, is as an economic steam header pressure control using a plurality of boilers of different sizes and using multiple fuels at different costs and under various process input constraint limits to operate the boilers. In this embodiment, the recurrent distribution network dynamically changes various fuel flows to associated boilers to generate steam at minimum cost while maintaining header pressure at or near setpoint while observing multiple constraints imposed by process, equipment and environmental limitations.

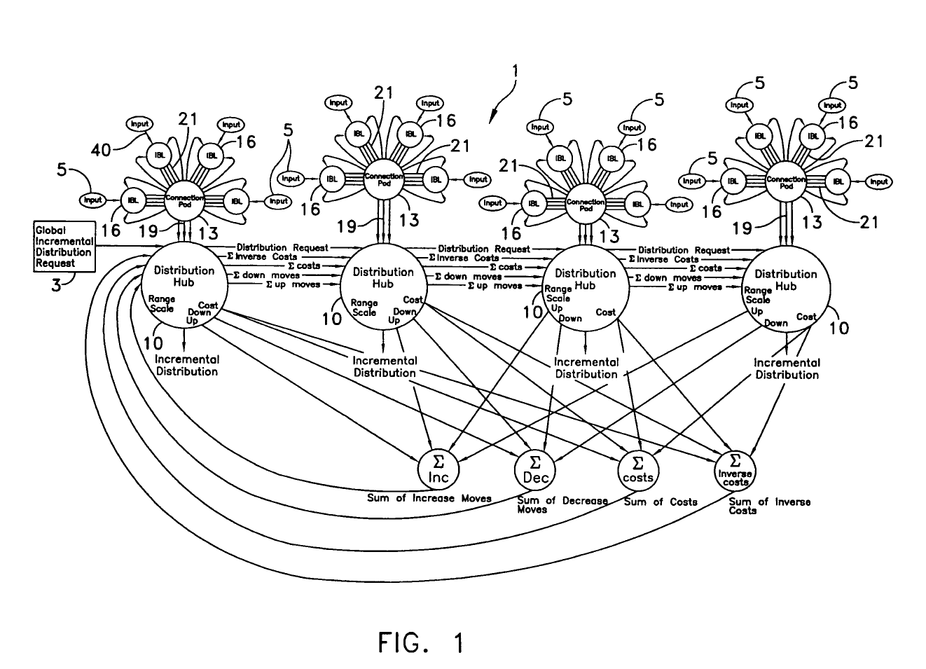

The recurrent distribution network of the invention shown schematically in FIG. 1, provides a plurality of distribution hubs 10 that work together to apportion a global distribution request 3 to the individual distribution hubs 10 which adjust and control the system through their respective controllable output devices (not shown in FIG. 1). The adjustments are made using a heuristic approach to problem solving. The controllable output devices control the controlled process variable and the global distribution request may be triggered when the controlled process variable is out-of-control, out-of-spec, out-of-range, or when it deviates to an unacceptable degree from setpoint. The global distribution request 3 may be based on a measurement of the controlled process variable and may be a request to restore or direct the controlled process variable to a setpoint or within a desired range of values. For “positive” global distribution requests, in which an additional medium is requested to adjust the controlled parameter, the least expensive medium is favored over more expensive media. For example, if steam pressure in an energy system is too low, and the steam pressure is increased by increasing fuel flow to respective boilers, the increased fuel flow that is least expensive, is favored for increasing the header pressure. Conversely, for negative global distribution requests, the more expensive medium is favored to be restricted. Furthermore, the control system of the invention may take into account further concerns when adjusting the output devices. For example, it may be desirable to insure that each of the systems or devices associated with an output device (for example, each boiler coupled to a fuel valve) operates continuously and is never turned “off”. Another concern may be the speed in which an adjustment is made, i.e., it may be desirable to increase a more expensive fuel flow if such an increase will more quickly deliver or restore the system to its desired operating range and speed is a concern. Similarly, another concern may be to restore the system to its desired operating conditions with minimal environmental impact.

Input boundary limiters 16 monitor process inputs 5 which may be dependant process variables, and apply signals 21 that may include inhibitory inputs or incremental inputs as corrective limiting moves, to the distribution hubs 10 via connection pods 13. Signals 21 from a plurality of input boundary limiters 16 may be summed at connection hubs 13 and provided to a corresponding distribution hub 10 as hub signals 19 where they may inhibit positive or negative output moves of the distribution hub 10, or correct for a process input that exceeds a constraint limit.

Distribution hubs are linked by summation of costs, summation of inverse costs, summation of decrease moves (out_Dn) and summation of increase moves (out_Up) as shown in FIG. 1. Each distribution hub 10 makes adjustments based on ratios calculated by other distribution hubs 10 by communicating with the other distribution hubs 10 also as shown in FIG. 1. Over several iterations, the entire system provides a trajectory based on heuristic rules, within constraint boundaries imposed by the input boundary limiters 16.

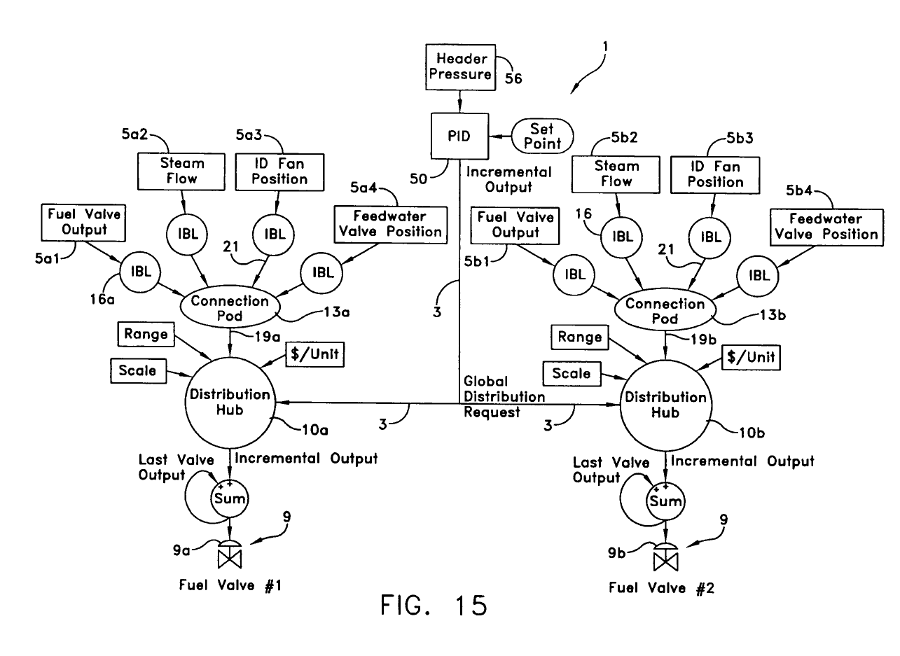

Recurrent distribution network 1 may provide control signals to multiple controllable output devices (such as fuel valves 9a and 9b shown in FIG. 15), based on input signals that may be limited by numerous input constraints. The global incremental distribution request 3 is based on the measurement of a controlled process variable. If the measured controlled process variable is not at set point, or it is out-of-spec, or out of control, the global incremental distribution request 3 sends a signal to the recurrent distribution network 1 requesting that the recurrent distribution network 1 adjust one or more controllable output devices which adjust the controlled process variable so that it is at setpoint or within a desired range, i.e., “in control”. The global distribution request 3 may continuously change. The global distribution request may oscillate from positive to negative with respect to a desired or pre-programmed setpoint or range for the controlled process variable. The oscillation may be the result of the network of the present invention, dynamically responding and controlling the controlled process variable as the controlled process variable changes. In this manner, the process noise associated with these oscillations may be used to iteratively solve for optimum control. For a quiet process, the system can be encouraged to converge to an optimum solution more quickly by adding random noise to the global distribution requests.

The distribution hubs of the invention cooperate to quickly find an appropriate control adjustment using heuristic techniques. For example, in one embodiment of the invention, recurrent distribution network 1 may find the closest minimum cost resource distribution solution using heuristic decent optimization techniques, and thereby iteratively solve and apply a distribution of global incremental distribution requests 3 to multiple controllable output devices based upon individualized incremental unit costs, output ranges, output scaling and/or process input constraint limits. The controllable output devices may include valves, motors, pumps, fans, controller setpoints and outputs, mechanical and electrical relays and switches, such as fuel valves 9a and 9b shown in FIG. 15. By adjusting/controlling the output devices, the controlled process variable may be controlled because the output devices influence the controlled process variable. For example, if overall steam header pressure is the controlled process variable, fuel flow to a boiler is an example of a controllable output device that affects the overall steam header pressure produced in an energy system.

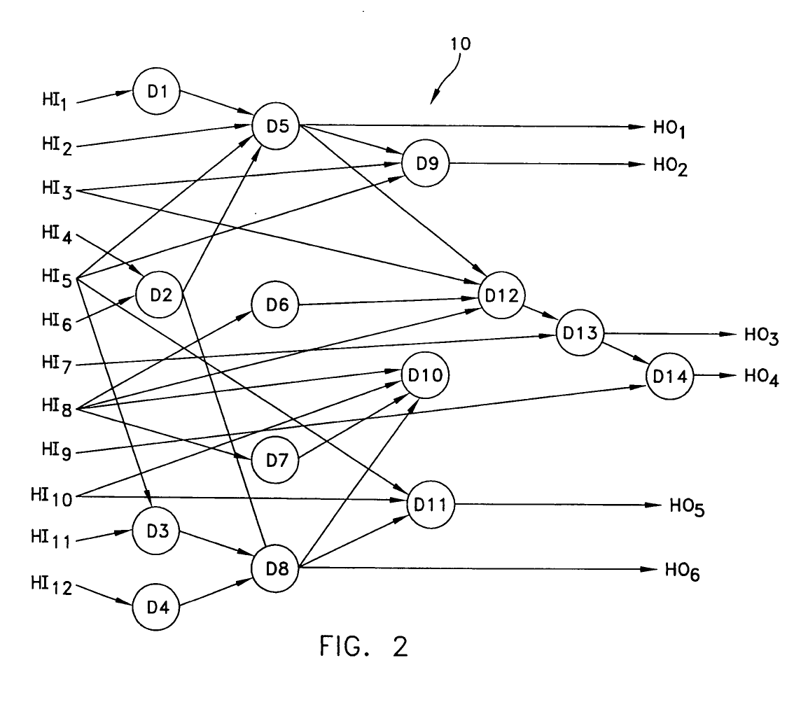

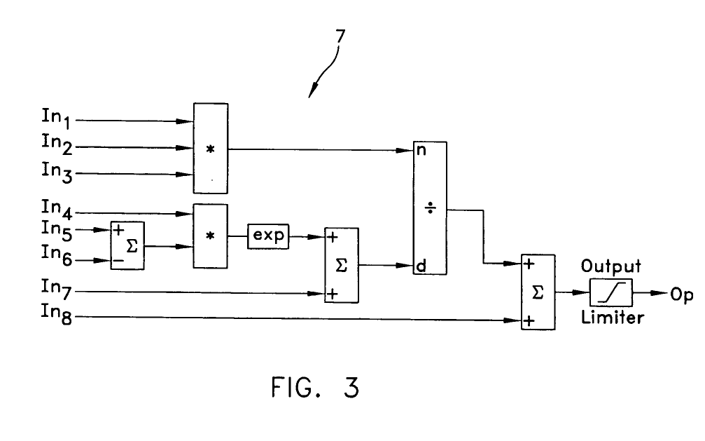

Recurrent distribution network 1 formed in accordance with the invention generally comprises one or more cooperatively interconnected distribution hubs 10. Recurrent distribution network 1 is scalable as any number of distribution hubs 10 may be used and the system with two distribution hubs 10 shown in FIG. 1 is exemplary only. Each connection pod 13 interconnects a plurality of input boundary limiters 16 with that particular connection pod's associated distribution hub 10 by way of a neural switching network. In a typical application of recurrent distribution network 1, a global incremental distribution request 3 to increase or decrease a controlled process variable, is accepted and processed by a recurrent neural network, such as neural network 7 shown in FIGS. 2 and 3. More particularly, one distribution hub 10 is required to provide control information to each associated controllable output device within the system or process being guided by recurrent distribution network 1. Implementation of the system may be accomplished using custom computer software for stand-alone personal computer applications and also with specialized software for use with proprietary distributed control systems (DCS) and programmable logic controllers (PLCs), specifically designed for process controls. Also, these circuits can be implemented using embedded firmware on dedicated computer boards or implemented with custom electronic hardware.

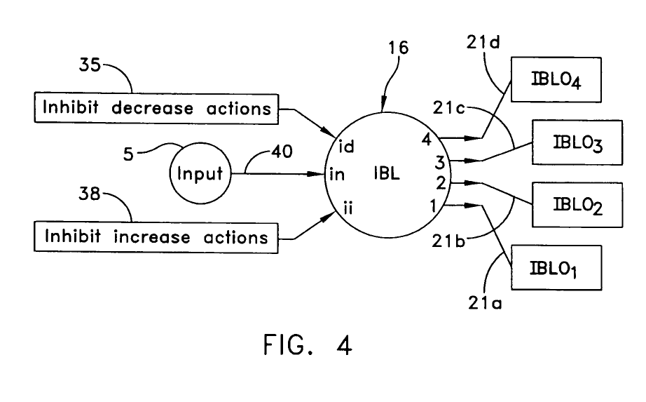

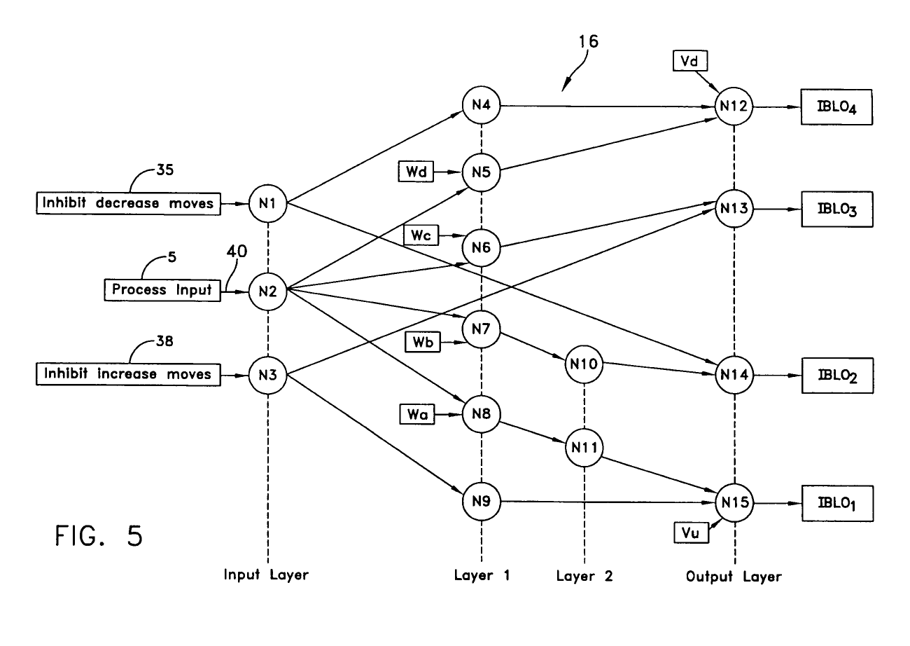

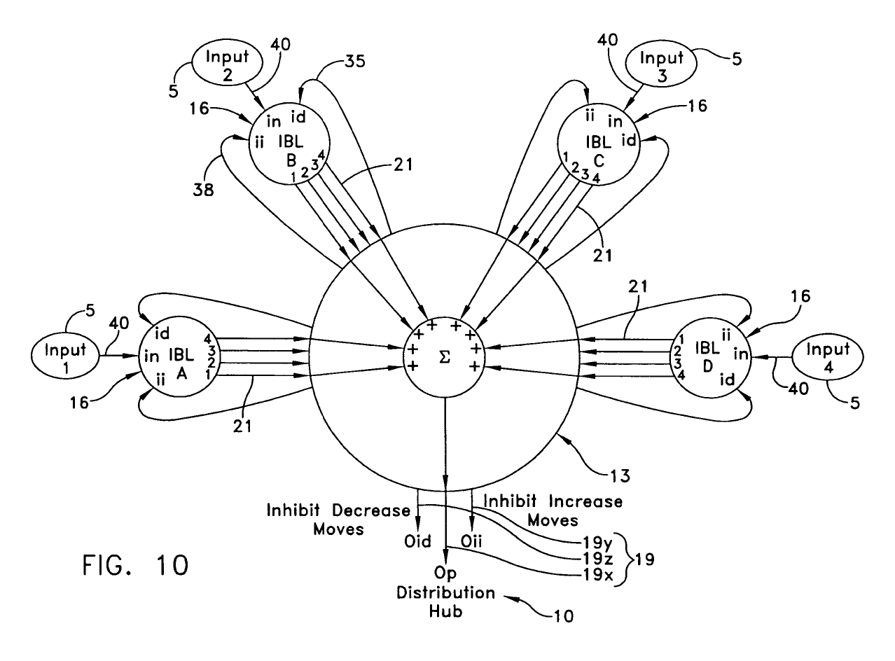

Each distribution hub 10 may receive inputs monitored by one or more process input constraint variables to prevent or limit the allotment of the global incremental distribution request 3 to its controllable output device. For example, the associated input boundary limits 16 may prevent the system from increasing or decreasing the controllable output device because one or more process input limits associated with the process inputs have been reached or the controllable output device may be placed in manual mode. Each distribution hub 10 is connected to an associated connection pod 13 that provides summed signals 19 to the corresponding distribution hub 10. Each connection pod 13 is a fully connected, neural switching network that is used to interconnect boundary limiters 16 in various ways to an associated distribution hub 10. Connection pods 13 are also scalable so any number of input boundary limiters 16 may be coupled to an associated distribution hub 10 through connection pod 13. Detailed examples of connection pods 13 are shown in FIGS. 10-13. Process input signal 40, representative of process input 5 is sent to input boundary limiters 16 and may be a single process measurement, in particular a dependent process variable. This is shown in FIGS. 4 and 5. Each input boundary limiter 16 compares the process input signal 40 to low and high constraint boundaries programmed in input boundary limiter 16. As a constraint boundary limit is approached, the associated input boundary limiter 16 outputs inhibitory signals through connection pod 13 to reduce the total allotment of the global incremental request 3 that would have normally been apportion to an associated distribution hub 10, if unconstrained, in the control direction appropriate to prevent a process input variable from exceeding a constraint boundary limit.

Each distribution hub 10 transmits and collects data from other distribution hubs 10 within the network, and uses that gathered information to formulate and apply an optimized distribution allotment to each participating controllable output device using heuristic rules and techniques. Each distribution hub 10 monitors one or more constrained process inputs 5 to prevent or limit the allotment of global incremental distribution requests 3 to any given controllable output device, i.e., so that particular controlled output devices are more or less favored for receipt of a global incremental distribution request 3 to increase or decrease the controlled process variable.

Referring to FIGS. 2 and 3, in one embodiment, a distribution hub 10 is formed by using fourteen sparsely interconnected generalized neural nodes D₁, D₂, D₃, . . . D₁₄, where the distribution hub 10 receives twelve inputs HI₁, HI₂, HI₃, . . . HI₁₂ and provides six outputs HO₁, HO₂, HO₃, . . . HO₆ as shown in FIG. 2. Each generalized neural node D₁, D₂, D₃, . . . D₁₄, enables all required circuits to be built using a single neural node 7 as shown in FIG. 3, and may be connected to process inputs, other neural node outputs or constant values. Each generalized neural node D₁, D₂, D₃, . . . D₁₄, often comprises eight inputs, IN₁, IN₂, IN₃, . . . IN₈ (FIG. 3) to yield one output, and may function according to the following exemplary neural node equation which provides an output value O_{P} (FIG. 3):
O_{P}=MAX(OPLO,MIN(OPHI, ((In₁×In₂×In₃)/(EXP(In₄×(In₅−In₆))+In₇)+In₈))).

Output values O_{P} may also be clamped within limits by selecting maximum (OPHI) and minimum (OPLO) limit values. Table 1 provides examples of typical input values (illustrated in FIG. 2), constant values, and interconnections used to create a single distribution hub 10.

TABLE 1
Distribution Hub Configuration

| Neuron | In1 | In2 | In3 | In4 | In5 | In6 | In7 | In8 | OPHI | OPLO |
|---|---|---|---|---|---|---|---|---|---|---|
| D1 | Inhibit | −1 | 1 | 0 | 0 | 0 | 0 | 1 | 1 | 0 |
| | Decreases | | | | | | | | | |
| D2 | Overall Gain | Distribution | 1 | 0 | 0 | 0 | 0 | 0 | 10000 | 0 |
| | | Range | | | | | | | | |
| D3 | Inc Unit Cost | Sum of Inverse | 1 | 0 | 0 | 0 | 0 | 0 | 10000 | 0 |
| | | Costs | | | | | | | | |
| D4 | Inhibit | −1 | 1 | 0 | 0 | 0 | 0 | 1 | 1 | 0 |
| | Increases | | | | | | | | | |
| D5 | D1 | D2 | Sum of | −100 | 1 | 0 | Inc Unit Cost | 0 | 10000 | 0 |
| | | | Costs | | | | | | | |
| D6 | Dist Request | 1000 | −1000 | 0 | 0 | 0 | 0 | 0 | 1 | 0 |
| D7 | Dist Request | 1000 | 1000 | 0 | 0 | 0 | 0 | 0 | 1 | 0 |
| D8 | D2 | 1 | D4 | −100 | 5 | 0 | D3 | 0 | 10000 | 0 |
| D9 | Inc Unit Cost | D5 | 1 | −100 | 1 | 0 | Sum | 0 | 10000 | 0 |
| | | | | | | | Decrease | | | |
| | | | | | | | Moves | | | |
| D10 | Dist Request | D7 | D8 | −100 | 1 | 0 | Sum Increase | 0 | 10000 | 0 |
| | | | | | | | Moves | | | |
| D11 | Inc Unit Cost | D8 | 1 | −100 | 1 | 0 | Sum Increase | 0 | 10000 | 0 |
| | | | | | | | Moves | | | |
| D12 | Dist Request | D5 | D6 | −100 | 1 | 0 | Sum | D10 | 10000 | −10000 |
| | | | | | | | Decrease | | | |
| | | | | | | | Moves | | | |
| D13 | D12 | 1 | 1 | 0 | 0 | 0 | 0 | IBL Inc | 10000 | −10000 |
| | | | | | | | | Out | | |
| D14 | % OP Scale | D13 | 1 | 0 | 0 | 0 | 0 | 0 | 10 | −10 |

Referring to FIGS. 2 and 3, input HI₁ provides a value to “inhibit decrease moves” such that as the inhibit value increases from zero to one, the total distribution allotment reduces from 100% to 0%, but in the decreasing direction only. The sum of unit costs is provided by input HI₂ as a summation of unit incremental costs from participating distribution hubs 10. HI₃ provides the sum of decrease moves or a summation of voted unit decrease moves from all participating distribution hubs 10. An overall unit gain is provided by input from HI₄ which may act to either increase or decrease the effective distribution range of a distribution hub 10, and is used for tuning the system. HI₅ provides an incremental unit cost which assigns an incremental cost of a particular distribution hub's output, e.g., the price of fuel. A distribution range is provided by input from HI₆ which is the effective control range of output from an associated distribution hub 10, in engineering units. HI₇ provides an IBL (input boundary limiter) incremental output to a particular input boundary limiter 16 such that a move or change request (e.g., to increase or decrease) is sent to a particular distribution hub 10 output to return an exceeded process input variable back within a constraint limit. HI₈ provides a global distribution request as an incremental distribution request made to all distribution hubs 10 to be allotted to various participating outputs in an optimum way. HI₉ provides a distribution percent of Op scale in which a scaling value converts distribution allotment requests from engineering units to percent output. HI₁₀ provides a summation of voted unit increase moves from all participating distribution hubs 10. HI₁₁ provides a sum of inverse unit costs in the form of a reciprocal of a summation of the reciprocal of all participating distribution hub 10 incremental unit costs. Input data from HI₁₂ inhibits increase moves such that as the inhibit value increases from zero to one, the total distribution allotment is reduced from 100% to 0%, but in the increasing direction only.

Referring again to FIG. 2, generalized neural node D₁ functions to provide an inverse value of an “inhibit decrease moves” request received via input from HI₁. Generalized neural node D₂ functions to provide the product of an overall gain, via input from HI₄, and a distribution range via input from HI₆. Generalized neural node D₃ provides the product of an incremental unit cost HI₉ and a sum of inverse costs, via input from HI₁₁. Generalized neural node D₄ provides an inverse of an “inhibit increase moves” request delivered via input from HI₁₂ Generalized neural node D₅ provides a “voted unit decrease move” output. Generalized neural node D₆ represents a global distribution request HI₈ that is treated true when less than zero, while generalized neural node D₇ represents a global distribution request HI₈ that is treated true when greater than zero. Generalized neural node D₈ provides a “voted unit increase move” as an output, and generalized neural node D₉ provides an incremental unit cost, decrease as an output. Generalized neural node D₁₀ provides an increase distribution move output, generalized neural node D₁₁ provides an incremental unit cost for increasing output. Generalized neural node D₁₂ provides a summation of voted distribution moves, while generalized neural node D₁₃ represents a sum of a final voted distribution and an incremental boundary limiter incremental output, HI₇ as an output, with generalized neural node D₁₄ providing a final scaled, incremental percent output with velocity limits as an output.

A single process measurement is received by each input boundary limiter 16 as shown in FIGS. 4 and 5. Each input boundary limiter 16 compares respective process input signal 40 from process input 5 against low and high constraint boundaries. The low and high constraint boundaries may be pre-programmed and may depend upon a physical limitation of the system, costs, process limitations, equipment limitations, safety issues associated with having the input value exceed a maximum value or other constraints. For example, a valve position may have a maximum or minimum physical limitation. As a constraint boundary limit is approached, the associated input boundary limiter 16 outputs signals through an associated network of connection pods 13 to reduce the total allotment of a global incremental request 3 that would have normally been apportioned to an associated distribution hub 10, if unconstrained, in the control direction appropriate to prevent a process input 5 from exceeding a constraint boundary limit. If process input signal 40 indicates that a process input 5 already exceeds a constraint boundary limit, the associated input boundary limiter 16 outputs a corrective signal through an associated network of connection pods 13 to an associated distribution hub 10 to return process input signal 40 back to the associated constraint boundary limit.

Input boundary limiters 16 are operatively coupled to connection pods 13 and as a process input variable 5 approaches a high constraint limit, an input boundary limiter 16 generates an inhibitory output signal 21b from 0 to 1, that provides inhibit moves that cause the process input signal 40 to decrease, where 0 means not inhibited and 1 means completely inhibited. An inhibitory signal 21 of one-half means partially inhibited by 50%. Inhibitory signals 21b for example, are passed to associated distribution hubs 10 through an associated network of connection pods 13 to reduce global distribution request 3 allotments to an associated distribution hub 10 and controllable output device, from 100% to 0%.

Likewise, as a process input 5, received as process input signal 40, approaches a lower constraint limit, input boundary limiter 16 generates a separate inhibitory output signal 21c from zero to one which provides inhibit moves that cause process input signal 40 to increase. For each input boundary limiter 16, this inhibitory signal is passed to an associated distribution hub 10 through an associated connection pod 13 to reduce, from 100% to 0%, global distribution request 3 allotments to distribution hubs' 10 output that would cause process input 5 to fall below a lower limit. The control direction of the inhibitory signal applied to the controllable output device of each distribution hub 10 depends upon the control direction of process input 5 to input boundary limiter 16 in response to a distribution hub 10 output move or change. Control direction is accommodated by proper interconnection of inhibitory signals to the distribution hub 10 by the network of connection pods 13.

If a process input signal 40 exceeds a high constraint limit, an associated input boundary limiter 16 generates an incremental output 21d as a corrective action that counteracts process input signal 40 and prevents that process input 5 from remaining above a predetermined high limit. For example, if a response to a global distribution request 3 would cause an uninhibited distribution hub to adjust a controllable output device to an extent that would cause a dependent process variable such as valve setting which may be process input 5, past a safe level or past its physical limitation, the associated input boundary limiter 16 inhibits increase actions associated with the distribution hub so that that particular distribution hub cannot adjust the associated controllable output device in a manner that would cause a dependent process input 5 to exceed a preset boundary limit. This incremental output is passed to an associated connection pod 13, where the incremental output signal is summed with all other input boundary limiter 16 incremental outputs connected to the same connection pod (FIGS. 10-13). The summed incremental output is then transferred via the associated network of connection pods 13 to HI₇, (incremental output) of an associated distribution hub 10 (FIG. 2).

On the other hand, if process input signal 40 is below a predetermined low constraint limit, input boundary limiter 16 generates a separate incremental output 21a as a corrective action to counteract process input signal 40 and increase process input 5 to the predetermined low limit. Such incremental outputs of the input boundary limiters 16, are passed to the associated network of connection pods 13. Each connection pod 13 sums the incremental output signals of all input boundary limiters 16 connected to the particular connection pod 13 (FIGS. 10-13). The summed incremental output is also transferred by the network of connection pods 13 to HI₇, (incremental output) of an associated distribution hub 10 (FIG. 2).

FIG. 4 also shows that input boundary limiter 16 has three inputs, inhibit decrease actions 35, inhibit increase actions 38 and process input signal 40, to monitor predetermined constraints placed upon the system. Thus, each input boundary limiter 16 supports two inhibitory inputs to prevent increase or decrease actions in response to process input signal 40 violating a predetermined high or low constraint limit. Inhibit decrease actions 35 and inhibit increase actions 38 may be provided by the other input boundary limiters 16 coupled to a connection pod 13, as shown in FIG. 10. Inhibit decrease actions 35 provide signals having a continuous range from zero to one, where zero gives the input boundary limiter 100% freedom and one gives input boundary limiter 0% freedom to take incremental actions to move or direct the output of a distribution hub 10 to reduce a process input 5 that is exceeding a predetermined high limit. The signal for inhibit increase actions 38 may range continuously from zero to one, where zero gives the input boundary limiter 16 one hundred percent and one gives input boundary limiter 16 zero percent freedom to take incremental actions upon a distribution hub 10 output to increase a process input 5 that is below a predetermined lower limit.

Each input boundary limiter 16 has four outputs, 21a (IBLO₁), 21b (IBLO₂), 21c (IBLO₃), and 21d (IBLO₄), shown in FIG. 4 and which may be summarized as follows. An incremental output is provided by IBLO₁ to increase a process input 5 so as to effect a change in the signal sent to the distribution hub 10. IBLO₁ is triggered by process input 5 falling outside a predetermined constraint limit that requires an increase control action to bring it back within the predetermined constraint limit. Falling below or above a constraint limit depends on the process action. For example, a tank level may be above a high limit, but may require a valve to open in order to reduce the level to a maximum level. In this example of direct control action, the valve controls the tank's discharge flow rate. If the valve controls the tank's inflow rate, the valve would be closed to reduce the tank's level. This is an example of reverse control direction. IBLO₂ provides inhibit moves that cause process input 5 to decrease. An inhibitory signal is generated as process input signal 40 approaches or falls outside a predetermined lower constraint limit that requires a decrease in control action to restore the process input to predetermined constraint limits. Alternatively, actions that cause process input 5 to increase are inhibited by IBLO₃. IBLO₃ provides an inhibitory signal as process input 5 approaches or exceeds a predetermined constraint limit that requires an increase in control action to restore the process input to predetermined constraint limits. An incremental output is provided by IBLO₄ to decrease process input 5 so as to effect a change in the signal from a connection pod 13 to decrease process input 5. IBLO₄ is triggered by process input 5 exceeding a predetermined constraint limit that requires a decrease in control action to restore the process input to predetermined constraint limits. Input boundary limiter 16 is often fabricated with fifteen generalized neural nodes 7 such as shown in FIG. 3.

FIG. 5 shows details of an exemplary input boundary limiter 16. Process input 5 has limits that are adjusted with input variables Wₐ, W_{b}, W_{c} and W_{d}. The range for each of these variables is from zero to one, which represents a percent of a process input variable scale. More particularly, Wₐ applies an incremental output to increase process input 5 when it falls below a lower constraint limit when the process requires reverse control action. As process input 5 approaches W_{b}, actions are inhibited that cause process input 5 to decrease. As process input 5 approaches W_{c}, actions are inhibited that cause that process input 5 to increase. For reverse control action, W_{d} applies an incremental output to decrease process input variable 5 when it exceeds an upper constraint limit.

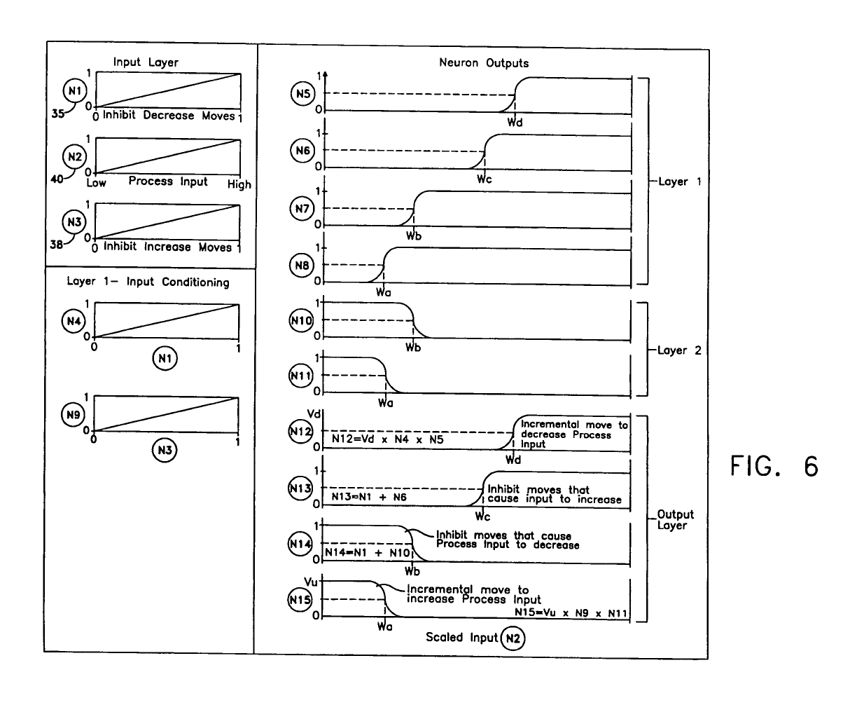

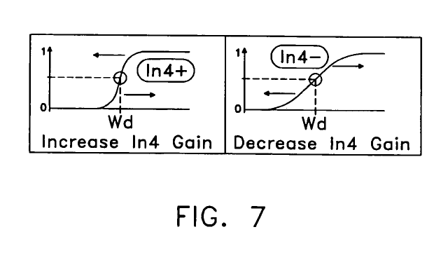

Input and output relationships for each input and neural node output are shown in FIG. 6. Nodes N₁, N₂, N₃ serve to process or condition input variables for use by generalized neural network 7. Nodes N₄ and N₉ are input inversion nodes. Nodes N₅ through N₁₅ have substantially sigmoidal outputs. In another exemplary embodiment, nodes N₅ through N₁₅ may have substantially linear outputs. Each node's output is depicted in relation to a process input signal 40 scaled from zero to one (N₂) in FIG. 6. Nodal outputs transition from zero to one at constraint breakpoints (Wₐ, W_{b}, Wₑ and W_{d}), where the value of the neural output is 0.5 directly at the breakpoint. Breakpoint slopes are adjusted by increasing or decreasing each node's HI₄ gain (FIG. 7). Increasing HI₄ node gain steepens breakpoint transitions resulting in tighter constraint breakpoints. Reducing HI₄ gain widens constraint breakpoints.

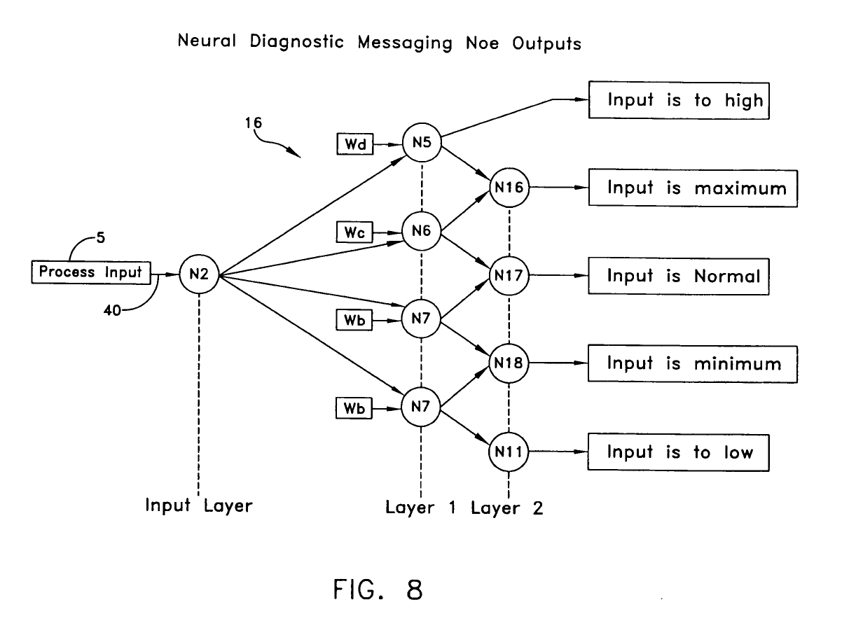

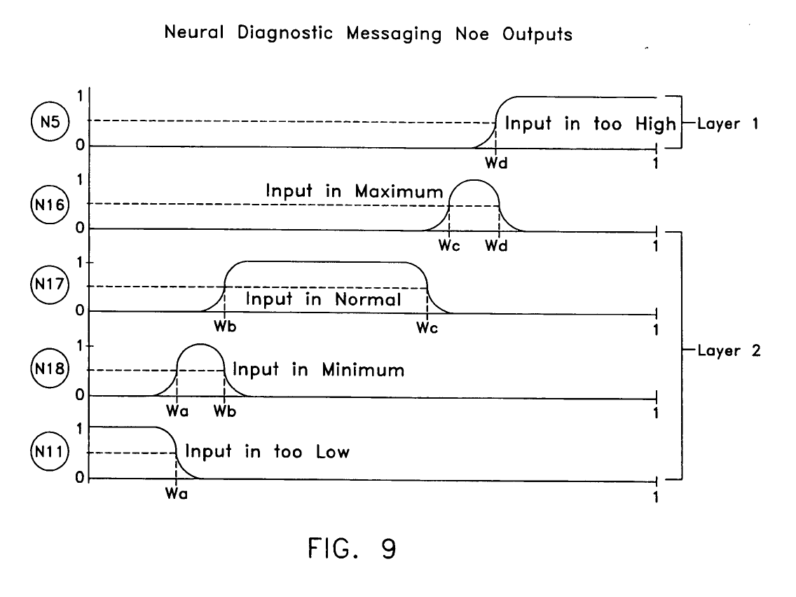

FIG. 8 schematically shows messages and alarms of input boundary limiter 16. In FIGS. 8 and 9, nodes N16, N17, N18 and N11 are added to the input boundary limiter 16 network to support text messages and alarms of input boundary limiter 16. In addition to the inhibit or incremental output signals, input boundary limiter 16 also notified the user of alarm conditions such as out of control limits. The graphs shown in FIG. 9 correspond to the messaging node outputs in FIG. 8. Thus, the various node outputs are shown in relation to a scaled process input (N2). Each input boundary limiter 16 with messaging capability is fabricated using eighteen generalized neural nodes 7. Each node is configured as shown in Table 2.

TABLE 2
Input Boundary Limiter Configuration Table

| Neuron | In1 | In2 | In3 | In4 | In5 | In6 | In7 | In8 | OPHI | OPLO |
|---|---|---|---|---|---|---|---|---|---|---|
| N1 | Inhibit Decrease | 1 | 1 | 0 | 0 | 0 | 0 | 0 | 1 | 0 |
| N2 | Process Input | Scale | 1 | 0 | 0 | 0 | 0 | Bias | 1 | 0 |
| N3 | Inhibit Increase | 1 | 1 | 0 | 0 | 0 | 0 | 0 | 1 | 0 |
| N4 | N1 | −1 | 1 | 0 | 0 | 0 | 0 | 1 | 1 | 0 |
| N5 | 1 | 1 | 1 | 400 | 0.8 | N2 | 1 | 0 | 1 | 0 |
| N6 | 1 | 1 | 1 | 400 | 0.6 | N2 | 1 | 0 | 1 | 0 |
| N7 | 1 | 1 | 1 | 400 | 0.4 | N2 | 1 | 0 | 1 | 0 |
| N8 | 1 | 1 | 1 | 400 | 0.2 | N2 | 1 | 0 | 1 | 0 |
| N9 | N3 | −1 | 1 | 0 | 0 | 0 | 0 | 1 | | 0 |
| N10 | N8 | −1 | 1 | 0 | 0 | 0 | 0 | 1 | 1 | 0 |
| N11 | N9 | −1 | 1 | 0 | 0 | 0 | 0 | 1 | 1 | 0 |
| N12 | N4 | N6 | Vd | 0 | 0 | 0 | 0 | 0 | 100 | −100 |
| N13 | N7 | 1 | 1 | 0 | 0 | 0 | 0 | N3 | 1 | 0 |
| N14 | N1 | 1 | 1 | 0 | 0 | 0 | 0 | N10 | 1 | 0 |
| N15 | N11 | N5 | Vu | 0 | 0 | 0 | 0 | 0 | 100 | −100 |
| N16 | N6 | −1 | 1 | 0 | 0 | 0 | 0 | N7 | 1 | 0 |
| N17 | N7 | −1 | 1 | 0 | 0 | 0 | 0 | N8 | 1 | 0 |
| N18 | N8 | −1 | 1 | 0 | 0 | 0 | 0 | N9 | 1 | 0 |

Nodes N₅, N₆, N₇, and N₈, signifying breakpoint gains (HI₄) may be changed to adjust breakpoint transitions (FIG. 7). Breakpoints are often adjusted on nodes N₅, N₆, N₇, N₈ using HI₅, and Wₐ=0.2 (20%), W_{b}=0.4 (40%), Wₑ=0.6 (60%), W_{d}=0.8 (80%).

Referring to FIGS. 10-13, each connection pod 13 is used to interface one or more input boundary limiters 16 to an associated distribution hub 10. Process input 5, represented by process input signal 40, is delivered to input boundary limiters 16. All of the signals 21 (generally designating signals 21a-d from FIG. 4) from associated input boundary limiters 16 connected to a particular connection pod 13, are routed through connection pod 13 and output by way of hub signals 19 sent to an associated distribution hub 10 (FIG. 10). Hub signals 19 represents a voted change in output, triggered by one or more process inputs 5 that reside outside predetermined constraint boundary limits. Hub signals 19 include summed process input signal 19x, inhibited increase moves signal 19y and inhibited decrease moves signal 19z. Hub signals 19 from a particular connection pod 13 are sent to the associated distribution hub 10 (as input HI₇ FIG. 2) such that a move request is sent to the distribution hub 10 associated with that particular connection pod 13 to return an exceeded process input signal 5 variable back to a constraint limit.

An exemplary illustration of this operation may be wherein process input 5, which may be a dependent process variable such as feed water valve position (see FIG. 15) is approaching a maximum value and the input boundary limiter 16 inhibits the hub signal 19 sent by connection pod 13 to the associated distribution hub 10 because if the distribution hub 10 were allowed to increase the controllable output device such an increase might cause or require the feed water valve position to exceed the maximum limit.

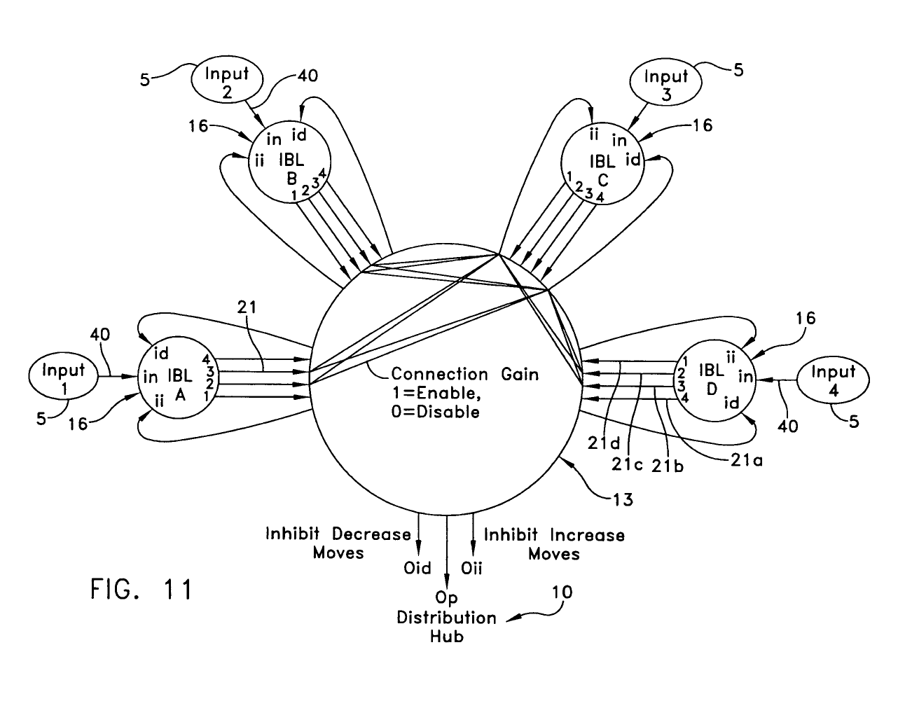

Connection pods 13 fully interconnect the inhibitory and incremental summed signals 21 of each input boundary limiter 16 to other input boundary limiters 16 connected to that connection pod 13. (FIGS. 11-13). By adjusting gains for each interconnection, internal wiring is effectively connected or broken. This enables internal connection pod wiring to be changed dynamically, as required, by adjusting connection gains.

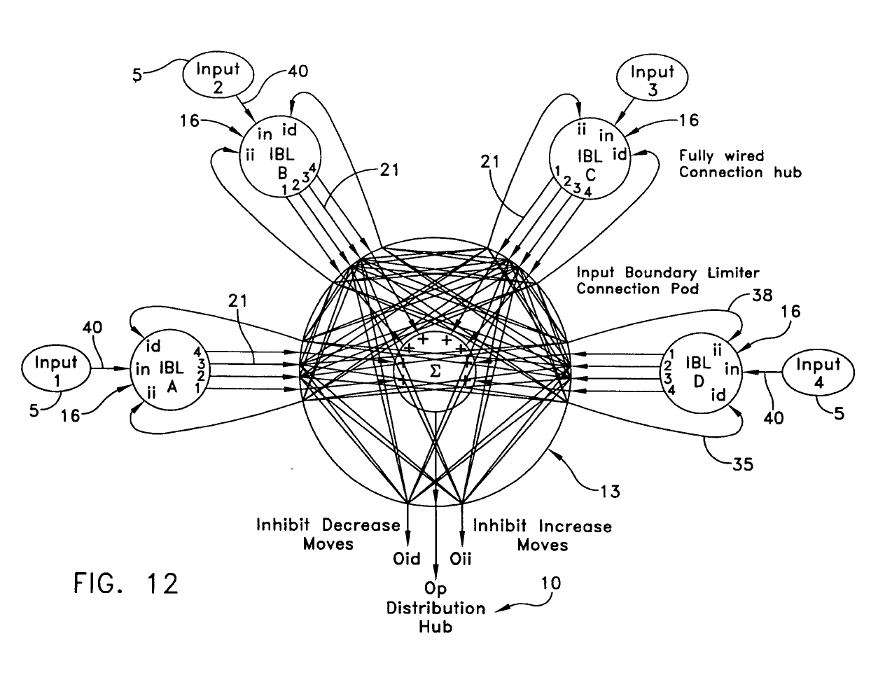

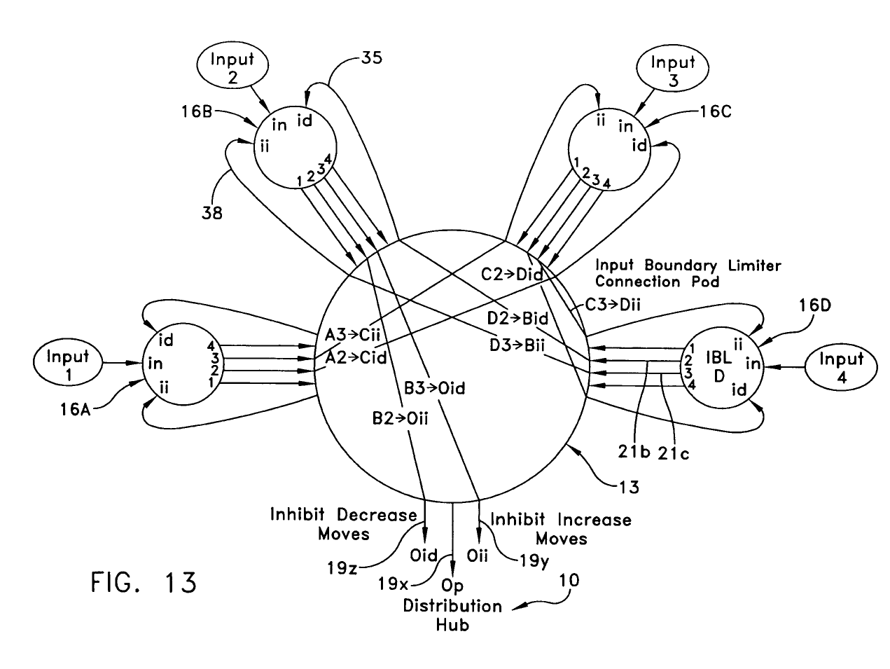

An exemplary, fully wired connection pod 13 is depicted in FIG. 12. In a typical application, connection gains are configured to link input boundary limiters 16 in a specific, predetermined order as illustrated in FIG. 13. FIG. 13 illustrates how input boundary limiters 16 are chained sequentially by enabling and disabling and disallowing connections within connection pod 13. Connections are configured to accommodate process input control directions and priorities. Input boundary limiters 16 are bypassed by dynamic disconnection or judicious routing. Connection gains may be configured using lookup tables to accommodate various permitted wiring combinations. FIG. 13 shows the origin of inhibit decrease actions 35 and inhibit increase actions 38 that are also shown in FIG. 4. The inhibitory inputs ii and id of input boundary limiters 16A are set to zero since input boundary limiters 16A is the first IBL in the chain. With respect to exemplary input boundary limiter 16B, FIG. 13 shows output 21b from input boundary limiter 16D delivered as input inhibit decrease action 35 to input boundary limiter 16B and FIG. 13 similarly shows output signal 21c from input bounder limiter 16D being delivered to input boundary limiter 16B as inhibit increase action 38. Input boundary limiter 16B's inhibit are finally routed to inhibited increase moves signal 19y and inhibited decrease moves signal 19z.

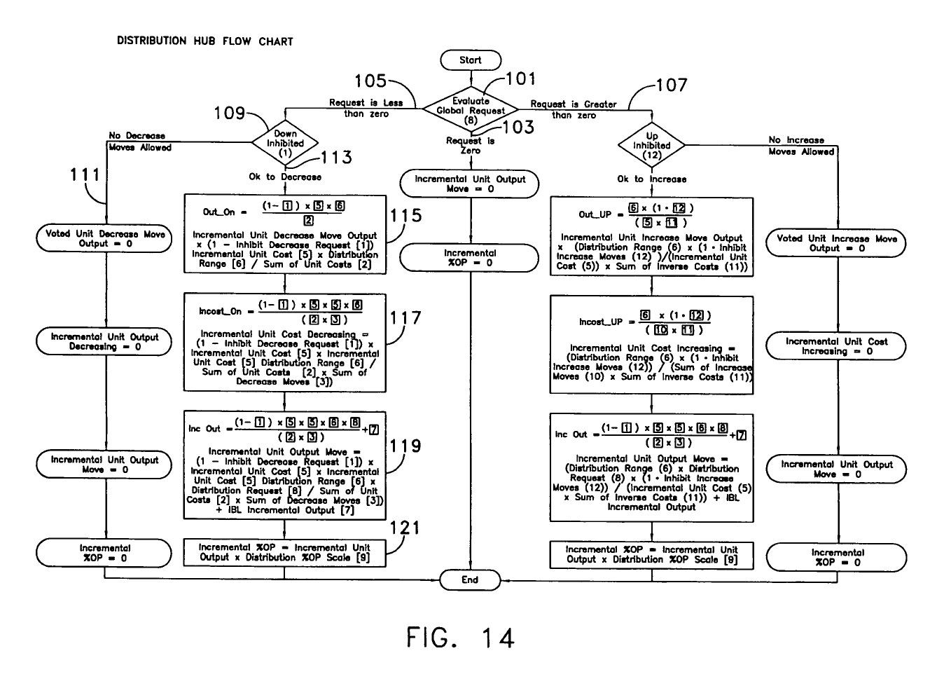

FIG. 14 is a flowchart showing the operation of a distribution hub. The global distribution request is evaluated at step 101. The global distribution request is indicative of the measured controlled process variable and may represent a request to adjust the controlled process variable to a predetermined value or range. The request may be zero 103, in which case no moves are required. The request may be less than zero 105, in which case it is desired to decrease the controlled process variable by way of decrease moves. The request may be greater than zero 107, in which case it is desired to increase the controlled process variable by way of increase moves. In the case where the request is less than zero 105, the network checks if down moves are inhibited 109. If no decrease moves are allowed 111, no adjustments are made. If it is ok to decrease 113, steps 115-121 are carried out to calculate decrease moves as shown in FIG. 14.

Distribution hubs 10 receive signals 19 from corresponding connection pods 13, and cooperatively communicate with each other to compare signals and exchange information according to heuristic rules as opposed to a strict algorithm.

An exemplary list of heuristic rules by which the distribution hubs operate by communicating with each other, is as follows:

For all distribution hubs selected for control:

Calculate Sum of Costs and Inverse Costs for all distribution hubs selected for control, as follows:
Sum of Costs=Cost1+Cost2+Cost3+Cost4 1)
Sum of Inverse Costs=1/((1/Cost1)+(1/Cost2)+(1/Cost3)+(1/Cost4)) 2)
Calculate Sum of Decrease and Increase Moves
Sum of Decrease Moves=Out_{—}Dn1+Out_{—}Dn2+Out_{—}Dn3+Out_{—}Dn4 3)
Sum of Increase Moves=Out_{—}Up1+Out_{—}Up2+Out_{—}Up3+Out_{—}Up4 4)
For each individual distribution hub, calculate ratio of individual output cost over total sum of costs. This ratio is used for individual distribution of decrease moves:
Cost1 Down Ratio=Cost1/(Sum of Costs) 5)
For each individual distribution hub, calculate inverse ratio of individual output cost over total of inverse individual costs. This ratio is used for individual distribution of increase moves:
Cost1 Up Ratio=(1/(Cost1×(Sum of Inverse Costs)) 6)
For each individual distribution hub, compensate up and down costing ratios with the distribution hub's control range. The control range of an output device for an associated distribution hub may be determined in comparison with other output devices. For example, if the output devices are valves and valve 1 flow is 10 times the flow through valve 2, range 1 associated with valve 1 may be “1” whereas range 2 associated with valve 2 may be “10”. Also, reduce up and down costing ratios with inhibitory signals from Input Boundary Limiters (IBLs):
Out_{—}Dn1=(Cost1 Down Ratio)×Range1×(1−Down Inhibit1) 7)
Out_{—}Up1=(Cost1 Up Ratio)×Range1×(1−Up Inhibit1) 8)
For Decrease Global distribution requests, calculate a ratio of distribution moves over the Sum of all Decrease Moves by the other Distribution Hubs. Then apportion the Global Distribution request by the final down ratio amount:
Dnalloc1=(Global Distribution Request)×Out_Dn1/(Sum of Decrease Moves) 9)
For Increase Global Distribution requests, calculate a ratio of distribution moves over the Sum of all Increase Moves by the other Distribution Hubs. Then apportion the Global Distribution Request by the final increase ratio amount:
Upalloc1=(Global Distribution Request)×Out_Up1/(Sum of Increase Moves) 10)

### EXAMPLE 1

Referring to FIG. 15, a control application for an exemplary steam generating system is schematically illustrated employing a recurrent distribution network 1 formed and operated in accordance with the invention. In this exemplary application, only two distribution hubs 10a and 10b are connected to two controllable output devices—fuel control valves 9a and 9b respectively. For clarity and brevity, many of the recurrent feedback connections illustrated in FIG. 1 are not shown in FIG. 15. A proportional, integral and derivative controller, PID 50, with an incremental output, is used to generate global distribution requests 3 to recurrent distribution network 1. If measured header pressure 56 from a steam header is less than set-point or below specified or desired values, PID controller 50 requests an increase in header pressure. PID controller 50 may be conventional. Such a request manifests itself as a global distribution request 3 that, in turn, requests an increase in total fuel flow, via actuation or adjustment of either or both of fuel control valves 9a and 9b of respective boilers. The increased fuel flow causes header pressure 56 to rise. Fuel control valves 9a and 9b are examples of the previously discussed controllable output devices. Recurrent distribution network 1 employs a heuristic problem solving approach and may split the total global distribution request 3 between fuel control valves 9a and 9b using heuristic rules and based upon a number of predetermined operational variables, e.g., fuel costs, efficiencies, participation and process constraints. For identical fuel control valves 9a and 9b with the same cost of fuels, efficiencies, participation and range, allocation to each valve may be split evenly. However, depending upon conditions, allocation ranges may be anywhere from [100% to fuel control valve 9a: 0% to fuel control valve 9b], to [0% to fuel control valve 9a: 100% to fuel control valve 9b]. Unconstrained, the less expensive fuel is favored over the more expensive fuel. For increases in total fuel demand, the less expensive fuel is allocated a larger portion of the total distribution, depending on the difference in fuel costs. Likewise, if the measured header pressure 56 from the steam header is greater than set-point or has a value above the desired or control range, PID controller 50 makes a global distribution request 3 to decrease total fuel flow. In one embodiment, recurrent distribution network 1 reduces the more expensive fuel more than the less expensive fuel based on the difference in cost of fuel prices, if unconstrained.

Input boundary limiters 16, however, constrain/inhibit the adjustments made by the distribution hubs 10. Summed signals 19a and 19b from respective connection pods 13a and 13b may inhibit the respective distribution hubs 10a and 10b. Fuel valve 9a may be connected to a first boiler and fuel valve 9b may be connected to a second boiler. Dependent process inputs 5a1-5a4 are associated with the first boiler and dependent process inputs 5b1-5b4 are associated with the second boiler. In an exemplary embodiment, process input 5a1 may be a fuel valve output that represents the position of fuel valve 9a. If an exemplary process input is maximized, such as the fuel valve output 5a1 of fuel control valve 9a at 100% output, an input boundary limiter 16 applies an inhibitory signal to prevent any more actions that would increase the constrained valve's output. Any distribution increase amount, normally apportioned to fuel control valve 9a by recurrent distribution network 1 from PID controller 50 responsible for control of header pressure 56, is applied to fuel control valve 9b, instead. As fuel control valve 9a approaches 100% output, an input boundary limiter 16 continues to apply a stronger inhibitory signal to continuously reduce the amount of increase allocated to fuel control valve 9a by recurrent distribution network 1.

If the maximum output limit for fuel control valve 9a is 90%, while fuel control valve setting 9a is greater than 90%, the corresponding input boundary limiter 16a applies a maximum inhibitory signal to prevent fuel control valve 9a from accepting any more increasing actions or directions from recurrent distribution network 1. At the same time, input boundary limiter 16a applies an incremental output signal, via connection pod 13a, to the associated distribution hub 10a to reduce fuel control valve 9a's output, until the valve position reaches the new 90% maximum output limit. Once the 90% maximum output position is achieved, input boundary limiter 16a reduces the incremental output to distribution hub 10a until fuel control valve 9a's downward motion ceases in order to maintain the maximum allowable output limit of 90%. The inhibitory signal, however, continues being applied by input boundary limiter 16a to prevent any increase actions or directions by recurrent distribution network 1 to fuel control valve 9a. A messaging or other system informs an operator when fuel control valve 9a is at maximum or above. The above similarly applies to fuel control valve 9b.

Additionally, a similar situation applies when the output of fuel control valve 9a or 9b is at minimum output position. For example, input boundary limiter 16a applies an inhibitory signal, via connection pod 13a, to distribution hub 10a to prevent recurrent distribution network 1 from directing additional decreasing actions to the minimally constrained valve output. If fuel control valve 9a is below an output minimum, input boundary limiter 16a applies an incremental output, via connection pod 13a, to distribution hub 10a, to increase fuel control valve 9a's output position. Input boundary limiter 16a continues to apply an incremental output to return fuel control valve 9a back to the minimum allowable valve position. As fuel control valve 9a approaches the minimum valve limit, input boundary limiter 16a reduces the magnitude of the incremental output to distribution hub 10a to slow down fuel control valve 9a's movement velocity. When the minimum output limit is reached, input boundary limiter 16a's incremental output is reduced to zero to hold fuel control valve 9a to the minimum valve limit. Input boundary limiter 16a continues to apply an inhibitory signal, via connection pod 13a to distribution hub 10a, to prevent recurrent distribution network 1 from taking actions that would reduce fuel control valve 9a below the minimum output value permitted. A messaging system also informs a controller when fuel control valve 9a is at minimum or below. Each input boundary limiter 16a applies the same action for any connected input process variable that reaches or exceeds a predetermined constraint limit.

The above-described control may be accomplished using the following heuristic rules and guidelines.
When more steam is required to meet demand or desired value, it is slightly more favorable to adjust boiler/fuel combinations with lower incremental steam costs than boiler/fuel combinations that are more costly.
When less steam is required to meet demand or desired value, it is slightly more favorable to adjust boiler/fuel combinations with high incremental steam costs than boiler/fuel combinations that are less costly.
In the short run, all boilers work together to maintain steam header balance with minimum stress on all boilers. Although moving all boilers together to manage large swings in steam demands may not be the most economical solution, it advantageously provides a longer term economic decision in terms of the most economical boiler's wear and cost of maintenance.
Over time, the least expensive steam producers are favored over the more costly ones. As the control variable (e.g., steam header pressure) wanders back and forth across setpoint, the least expensive steam producers eventually take the majority of the load, while the more expensive steam producers are reduced to minimum values.

The incremental cost per unit of steam cost may be continuously calculated for each boiler based on cost of swing fuels in $/MMBtu, selected swing fuels for each boiler, and the incremental efficiencies of each boiler for the fuel swing selected. The efficiency may be based on historical data and may be an approximation. Efficiency versus load curve data is not required. In addition to fuel costs, additional process constraints may include minimum/maximum steaming limits, air emission limits, drum level and level stability, fuel and MMBtu constraints, performance degradation of particular boilers, and other constraints. The constraints may further determine how the control of the individual output devices (i.e., fuel valves) is apportioned between the respective distribution hubs. The dynamic allocation approach of the invention takes into account each boiler's individual operating constraints and groups the boilers to prevent one boiler from taking all of the load swings and adjusts multiple fuels to obtain the most economic operating solution.

Although described in conjunction with the header pressure embodiment, the control system of the present invention may be used in various other applications. In a power factor control system, for example, the distribution hubs may be used to control local and global transmission line power factors by manipulating excitation voltages of multiple electrical generators situated at arbitrary locations. The input boundary limiters may monitor and manage local and global constraints, including various voltages, watts, vars and temperatures. Transformers with voltage tap changers may also be included for distribution. In another exemplary embodiment, the control system of the invention may find application in compressed air systems. The distribution hubs may coordinate various compressors of varying sizes and types to supply air at minimum cost while observing local and global constraints. In yet another embodiment, the control system of the invention may be used in water mining systems. In this exemplary embodiment, distribution hubs may distribute water to various spray nozzles to irrigate and digest ore, while observing various local and global constraints and objectives, such as minimizing total water flow while observing pipe velocities, specific gravity limits, tank levels, and conveying loads. In still another exemplary embodiment, the control system of the invention may find application in distribution of solid fuels onto a boiler grate. In this embodiment, the distribution hubs may distribute solid fuel such as bark, sludge, coal and tire chips onto a moving grate of an incinerator or power boiler. Multiple screw feeders may be controlled while observing constraints and control objectives from the input boundary limiters directed to maintaining an even distribution of solid fuel by observing differential pressures across various grate zones and grate zone temperatures. In yet another exemplary embodiment, the control system of the invention may be used to provide the even distribution of bark on a moving grate using pseudo cost objectives in the form of differential pressures across various gate sections.

The preceding merely illustrates the principles of the invention. It will thus be appreciated that those skilled in the art will be able to devise various arrangements which, although not explicitly described or shown herein, embody the principals of the invention and are included within its spirit and scope. Furthermore, all examples and conditional language recited herein are principally intended expressly to be only for pedagogical purposes and to aid the reader in understanding the principals of the invention and the concepts contributed by the inventors to furthering the art, and are to be construed as being without limitation to such specifically recited examples and conditions. Moreover, all statements herein reciting principals, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A control apparatus for controlling a controlled process variable in a system, said control apparatus comprising:
a plurality of cooperative distribution hubs, each coupled to an associated controllable output device that affects said controlled process variable;
a corresponding plurality of connection hubs, each inputting information to a corresponding distribution hub and coupled to a plurality of boundary limiting devices, each boundary limiting device receiving at least an input signal indicative of a corresponding dependent process variable and including limiting means for comparing said input signal to low and high boundary limits, and sending means for sending output signals to said connection hub;
means for sending a global request to adjust said controlled process variable, to said plurality of cooperating distribution hubs; and
adjusting means for said plurality of cooperating distribution hubs cooperatively adjusting at least one of said controllable output devices to adjust said controlled process variable using heuristic rules, responsive to said global request, and based on said information.

2. The control apparatus as in claim 1, wherein said output signals comprise at least one of said input signal, an inhibit move signal that inhibits said input signal, and an incremental output signal that counteracts said input signal.

3. The control apparatus as in claim 2, wherein said output signals include said input signals and each connection hub sums said input signals.

4. The control apparatus as in claim 1, wherein said means for sending a request includes means for measuring and monitoring said controlled process variable and said request is generated when said controlled process variable is out-of-control.

5. The control apparatus as in claim 1, wherein one of said input signals provided to a first one of said boundary limiting devices suggests a change in a first controllable output device and said output signals from said first one of said boundary limiting devices suggest a lesser change in said first controllable output device.

6. The control apparatus as in claim 1, wherein said system is an energy control system and each of said controllable output devices comprises a valve that controls fuel flow.

7. The control apparatus as in claim 6, wherein said controlled process variable is header pressure and said adjusting means causes fuel flow and header pressure to change.

8. The control apparatus as in claim 7, wherein each of said valves controls fuel flow to a separate boiler.

9. A method for controlling a controlled process variable in a system, comprising:
providing a plurality of cooperative distribution hubs, each coupled to an associated controllable output device that affects said controlled process variable and a corresponding plurality of connection hubs, each connection hub coupled to a plurality of boundary limiting devices,
causing an input signal indicative of a dependent process variable to be delivered to each boundary limiting device, each boundary limiting device comparing said input signal to at least one boundary limit and sending output signals including said input signal, to an associated one of said connection hubs;
said connection hubs sending information based on said output signals, to an associated one of said distribution hubs;
sending a global request to control said controlled process variable, to said plurality of cooperating distribution hubs; and
said plurality of cooperating distribution hubs cooperatively adjusting at least one of said controllable output devices to control said controlled process variable by exchanging said information and using heuristic rules, responsive to said global request and based on said information.

10. The method as in claim 9, wherein said sending output signals comprises at least one of sending said input signal, sending an inhibit moves signal that inhibits said input signal, and sending an incremental output signal that counteracts said input signal.

11. The method as in claim 10, further comprising each connection hub summarizing at least one of said output signals.

12. The method as in claim 9, wherein said plurality of cooperating distribution hubs cooperatively adjusting further comprises said plurality of distribution hubs exchanging cost information and inverse cost information with each other.

13. The method as in claim 9, wherein said plurality of cooperating distribution hubs cooperatively adjusting includes said plurality of cooperating distribution hubs cooperatively adjusting at least one of said controllable output devices based upon relative capabilities of said output devices.

14. The method as in claim 9, further comprising sending further signals to each of said plurality of boundary limiters coupled to a first one of said connection hubs, said further signals including inhibit decrease actions and inhibit increase actions.

15. The method as in claim 14, wherein said further signals are sent by other of said input boundary limiters coupled to said first one of said connection hubs.

16. The method as in claim 9, further comprising each connection hub summarizing said output signals and wherein said information comprises at least a summary of said output signals.

17. The method as in claim 16, wherein said distribution hubs collectively apportion how much each distribution hub adjusts said corresponding controllable output device by comparing respective information provided to said associated distribution hubs.

18. The method as in claim 9, wherein said information includes down moves information for adjusting said associated controllable output devices and up moves information for adjusting said associated controllable output devices and said distribution hubs exchange said up moves information, said down moves information, cost information and inverse cost information.

19. The method as in claim 9, wherein said plurality of cooperating distribution hubs cooperatively adjusting comprises said plurality of cooperating distribution hubs cooperatively and responsively adjusting at least one of said controllable output devices to minimize costs in setting said controlled process variable to a desired value.

20. The method as in claim 9, further comprising measuring said controlled process variable and comparing said measured controlled process variable to a control range, and wherein said sending a global request takes place when said controlled process variable is out of said control range.

21. The method as in claim 9, wherein said plurality of cooperating distribution hubs cooperatively adjusting comprises said plurality of cooperating distribution hubs cooperatively and responsively adjusting at least one of said controllable output devices to direct said controlled process variable to a control range in a minimal adjustment time.

22. The method as in claim 9, wherein said heuristic rules included heuristic rules pertaining to how said controllable output devices interact to adjust said controllable output devices.

23. The method as in claim 9, wherein said using heuristic rules comprises considering and weighting a plurality of characteristics pertaining to said controllable output devices.

24. The method as in claim 9, wherein said system comprises an energy system, said controlled process variable comprises steam header pressure, said controllable output devices comprise fuel valves and said heuristic rules favor increasing fuel valves that supply inexpensive fuel over fuel valves that supply expensive fuel.

25. The method as in claim 9, wherein a first distribution hub of said plurality of distribution hubs, adjust one of said controllable output devices based on a calculation performed by at least a further distribution hub of said plurality of distribution hubs.
